(19) United States
(12) Patent Application Publication
(10) Pub. No.: US 2025/0041948 A1
(43) Pub. Date: Feb. 6, 2025

(54) A quick-change type tool holder structure with high positioning accuracy

(71) Applicant: Beijing Worldia Diamond Tools Co., Ltd, Chaoyang District Beijing (CN)

(72) Inventors: JiaLiang DUAN, Beijing (CN); Qi HAN, Beijing (CN); ZongChao ZHANG, Beijing (CN)

(21) Appl. No.: 18/716,401

(22) PCT Filed: Sep. 19, 2022
(86) PCT No.: PCT/CN2022/119605

§ 371 Date: Jun. 4, 2024

(30) Foreign Application Priority Data
Jun. 1, 2022 (CN) 202221346858.X

(51) Int. Cl. B23B 27/16

(52) U.S. Cl. CPC B23B 27/16

(57) ABSTRACT

The present invention provides a quick-change type tool holder structure with high positioning accuracy, comprising a cutting insert, a tool support rod and a tool holder connected in turn, said tool support rod and tool holder having a through hole in the centre of the cutting insert and the tool holder, a Threaded Insert Fitting Holes is provided in the through hole, said Threaded Insert Fitting Holes are connected to the cutting insert and the tool holder respectively at each end of the screw, the Limit Fitting Surface are provided as a cutting hole on the internal cylinder surface of the cutting hole of the cutting support rod close to the cutting insert at the end of the cutting hole, and the said Limit Fitting Surface is connected in a matching manner with the cutting insert. The present invention has the following beneficial effect: by connecting the Limit Fitting Surface with the tool holder through the Threaded fasteners, it avoids the opening of threads on the tool support rod, and then the tool support rod can be used with the use of cemented carbide material, combined with the structure of the mating holes, which solves the technical problem of the existing tool holders with an overly complex structure, and obtains a simple structure and a high positioning accuracy of the structure of the tool support rod.

### TECHNICAL FIELD

The present invention relates to the field of cutting tools technology, and in particular to a quick-change type tool holder structure with high positioning accuracy.

### BACKGROUND TECHNOLOGY

At present, the existing tool is generally fixed in the way of welding on the tool holder, in a long time on the metal surface cutting, the cutting insert of the tool is bound to wear, because the tool and the tool holder for the fixed together as a one-piece structure, long-term use of the damaged tool and the tool holder can only be thrown away as a whole, which results in a waste of materials.

In order to solve the above problems, the method currently used in the market is: the cutting insert of the tool is divided into two parts with the support rod and threaded for connection, and then when the cutting insert is worn out, only the cutting insert needs to be replaced.

However, the above method is problematic when applied to carbide tools, as it is too difficult to thread the carbide material, and therefore it is not possible to use the thread directly for the connection.

Therefore, in actual use, there appears, for example, CN212420429U disclosed in a Chinese patent, a quick-change high positioning accuracy HSK tool holder, which is capable of restricting the axial movement of the tension screw by providing a removable cover plate in a rough hole of the support rod of the tool holder, i.e., by the tension screw and the cover plate being used in conjunction with each other, it is possible to achieve a convenient replacement of the cutting insert when the cutting insert is worn out.

However, the existence of complex structures such as the cover plate in this structure requires the cover plate to be assembled with the tensioning screws, which makes the assembly of the tool holder and cutting insert more difficult.

### Content of the Invention

A quick-change type tool holder structure with high positioning accuracy is provided by the present invention in response to the deficiencies in the existing technology, which solves the technical problem of an overly complex structure in the existing tool holders.

A quick-change type tool holder structure with high positioning accuracy according to an embodiment of the present invention, comprising a cutting insert, a support rod and a tool holder sequentially connected, said support rod and the tool holder being provided with a connected through hole in the centre of said through hole, said Threaded Insert Fitting Holes being provided with a Threaded fasteners inside said through hole, said Threaded fasteners being connected to the cutting insert and the tool holder respectively at each end of the said cutting insert, said Limit Fitting Surface of said support rod being provided with a cutting insert mating hole in an inner cylindrical surface close to the cutting insert end, and said Limit Fitting Surface being connected with the cutting insert mating hole.

The technical principle of the present invention is as follows: a Threaded fasteners is used to pass through the tool holder to directly connect the tool holder with the cutting insert, while the Limit Fitting Surface are used to fit between the cutting insert and the tool holder mating holes to ensure the axial and radial positioning accuracy of the cutting insert and the tool holder mating holes.

Compared with the existing technology, the present invention has the following beneficial effects: connecting the cutting insert and the tool holder through Threaded fasteners, avoiding the opening of threads on the tool support rod, and then the tool support rod can be used with the use of cemented carbide material, combined with the support holes in the structure, which solves the technical problem of the existing tool holders that the structure is too complex, and obtains a simple structure and a high positioning accuracy of the structure of the tool holder.

Further, one end of said Threaded fasteners is provided with a threaded hole for connection to the cutting insert and the other end of said Threaded fasteners is provided with male threads for connection to the tool holder.

Further, said Threaded fasteners are provided with Allen keyhole near the male threads side.

The Allen wrench snaps into the Allen keyhole, which in turn facilitates the attachment of the Threaded fasteners to the tool holder.

Further, said cutting insert is provided with a step shaft at one end, said step shaft having a Fitting Section at the Primary End, said step shaft having a Threaded Column at the Secondary End, said Threaded Column being connected to the Threaded Hole, said Fitting Section being Cutting Insert Fitting Holes.

Further, said Cutting Insert Fitting Surface comprise two Cutting Insert Fitting Holes, with an avoidance slot between the two said Cutting Insert Fitting Surface.

Further, said Fitting Section comprises two Overshooting Insert Fitting Surfaces, an avoidance slot is also provided between the two said Overshooting Insert Fitting Surfaces, a Clearance Groove is provided at the point where said Cutting Insert is connected to the Step Shaft, the two said Overshooting Insert Fitting Surfaces correspond to each other on the two Cutting Insert Insert Fitting Surfaces, the said avoidance slot on the Fitting Section corresponds to the avoidance slot of the Cutting Insert Fitting Holes.

Further, the end face of said Cutting Insert Fitting Surface to which said support rod is attached to the Cutting Insert Insert Fitting Surface is a Limit Fitting Surface, the portion of said Cutting Insert Fitting Surface exposed at one end of the Cutting Insert Fitting Surface to which the Limit Fitting Surface is attached is a Limit Fitting Surface, said Limit Fitting Surface and Limit Fitting Surface are mated with each other.

Further, said cutting insert is provided with a Main Cooling Holes in the centre, said cutting insert has a cutting edge disposed circumferentially uniformly at one end of the cutting insert away from the support rod, said cutting insert has Support Cooling Holes disposed circumferentially uniformly at one side of the cutting insert close to the cutting edge, all of said Support Cooling Holes being connected to the Main Cooling Holes, said Threaded fasteners are provided with a cooling through hole in the centre, and said Cooling Through Holes are connected to the main cooling channel through holes in the tool holders.

Further, said Support rod Fitting Surface is provided at one end of the tool holder away from the cutting insert, said tool holder mating hole is provided in the centre of one side of the tool holder connected to the support rod and said Support od Fitting Surface is connected to the tool holder mating hole in a surplus fit.

Further, said support rod is made of carbide, and said cutting insert and tool holder are made of alloy steel.

### Beneficial Effects of the Present Invention:

1. Setting threads on the cutting insert and tool holder made of alloy steel and the threads on the Threaded fasteners enables fast mounting and dismounting of the cutting insert on the tungsten carbide support rod.
2. The use of Cutting Insert Fitting Holes and Fitting Section ensures the axial positioning accuracy of the cutting insert and the support rod, and the use of Limit Facing Surface and Limit Fitting Surface fit ensures to ensure the radial positioning accuracy of the cutting insert and the support rod.
3. Adopting cooling through holes to connect the Main Cooling Holes and Support Cooling Holes, so that the cooling medium can flow directly from the cutting insert's Support Cooling Holes to cool down the cutting insert.

### ILLUSTRATE

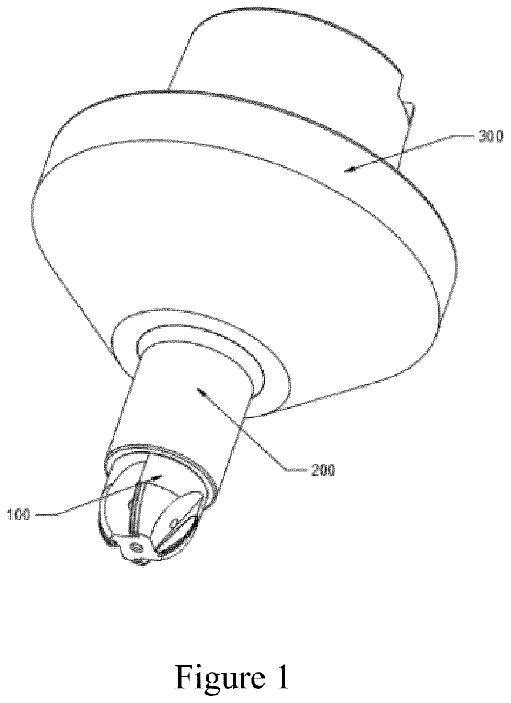

FIG. 1 shows an axial side view of a quick-change type tool holder structure with high positioning accuracy of an embodiment of the present invention.

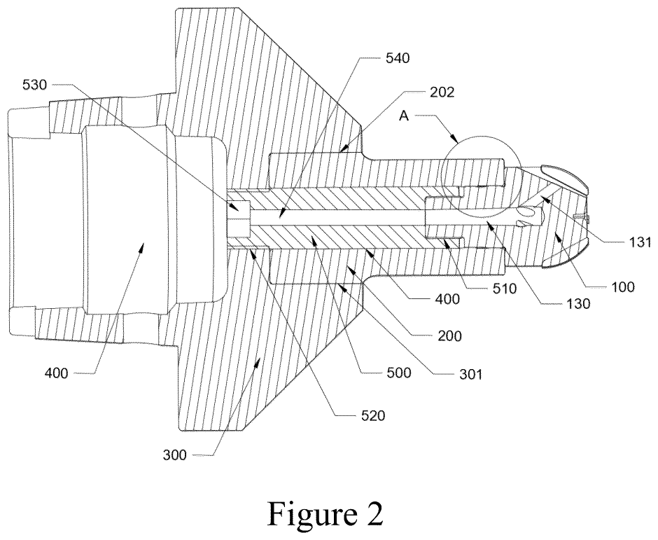

FIG. 2 shows a sectional view of the structure of a quick-change type tool holder with high positioning accuracy of an embodiment of the present invention.

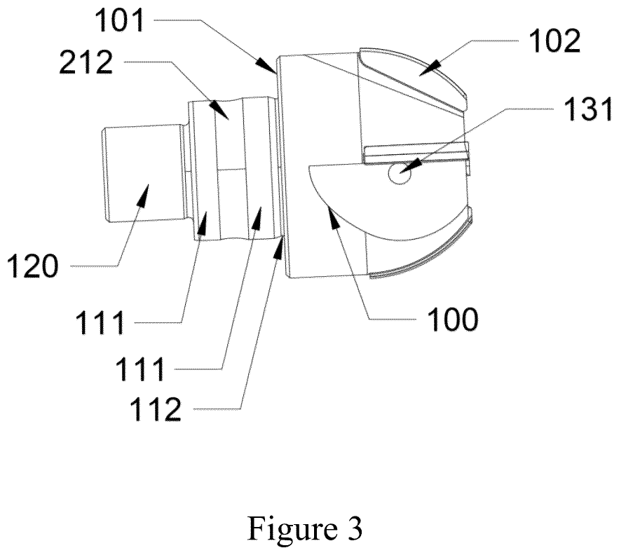

FIG. 3 shows a cutaway view of an embodiment of the cutting insert of the present invention.

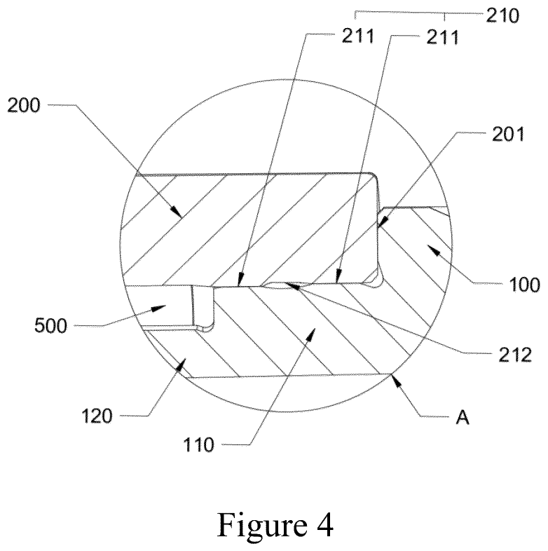

FIG. 4 shows a partially enlarged view of part A of FIG. 2.

In the above accompanying drawings: 100, Cutting insert; 101, Limit Fitting Surface; 102, Cutting Edge; 110, Fitting Section; 111, Overshooting Fitting Surface; 112, Clearance Grooves; 120, Threaded Columns; 130, Main Cooling Holes; 131, Support Cooling Holes; 200, Support rods; 201,Limit Facing Surface; 202, Support rod Fitting Surfaces; 210, Cutting Insert Fitting Holes; 211, Cutting Insert Fitting Surfaces; 212, avoidance slot; 300, tool holder; 301, tool holder mating hole; 400, through hole; 500, Threaded fasteners; 510, threaded holes; 520, male threads; 530, Allen keyhole; 540, cooling through hole.

### Practical Way of Doing Sth.

The technical solutions in the present invention are further described below in connection with the accompanying drawings and embodiments.

As shown in FIG. 1, the structure of the quick-change tool holder 300 with high positioning accuracy includes a cutting insert 100, a support rod 200, and a tool holder 300 that are connected in sequence, specifically the cutting support rod 200 is made of cemented carbide, which makes the durability of the cutting support rod 200 improved, and the cutting insert 100 and the tool holder 300 are made of alloy steel, which is a material that is relatively easy to machine threads and has excellent mechanical properties in various aspects.

As shown in FIG. 2, the support rod 200 and the tool holder 300 are provided with a through hole 400 in the centre, and a Threaded fasteners 500 is provided in the through hole 400, and both ends of the Threaded fasteners 500 are connected to the cutting insert 100 and the tool holder 300, and specifically, one end of the Threaded fasteners 500 is provided with a Threaded holes 510 that is connected to the cutting insert 100, and the other end of the Threaded fasteners 500 is provided with male threads that are connected to the tool holder 300. 520, the Allen keyhole 530 is provided on the side of the Threaded fasteners 500 close to the male threads 520, i.e., there is a section of threads at the through hole 400 of the tool holder 300, which threads are mated with the male threads 520, and the Allen keyhole 530 facilitates the use of a Allen wrench to secure the male threads 520 to the tool holder 300.

As shown in FIGS. 2-4, the through hole 400 of the support rod 200 is provided as the Cutting Insert Fitting Holes 210 on the inner cylindrical surface near one end of the cutting insert 100, and the Cutting Insert Fitting Holes 210 is connected with the cutting insert 100, and the specific end of the cutting insert 100 is integrally moulded with a stepped shaft, and the big end of the stepped shaft is the Fitting Section 110, and the Primary End of the stepped shaft is the Threaded Column 120, and the Threaded Column 120 is connected with the threaded hole 510, and the quick replacement and installation of the cutting insert 100 can be achieved by rotating the double-headed screw 500; the Fitting Section 110 is stuck into the Cutting Insert Fitting Holes 210, and the high precision fit between the Fitting Section 110 and the Cutting Insert Fitting Holes 210 can be ensured by rotating the double-headed screw 500; the Fitting Section 110 is stuck into the Cutting Insert Fitting Holes 210, and the Cutting Insert Fitting Holes 210 can be installed by rotating the Threaded fasteners 500, and the Cutting Insert Fitting Holes 210 can be replaced and installed quickly. Threaded fasteners 500 can be rotated to achieve fast replacement and installation of the cutting insert 100; the Fitting Section 110 is inserted into the Cutting Insert Fitting Holes 210, and the positioning of the cutting insert 100 and the support rod 200 is ensured by the high-precision fit between the Fitting Section 110 and the Cutting Insert Fitting Holes 210.

As shown in FIGS. 3-4, the Cutting Insert Fitting Holes 210 include two Cutting Insert Fitting Surface 211, and the two Cutting Insert Fitting Surface 211 are provided with an avoidance slot 212, the Fitting Section 110 includes two Overshooting Fitting Surfaces 111, and the two Overshooting Fitting Surfaces 111 are also provided with an avoidance slot 212, and the Cutting Insert Fitting Surface 100 is equipped with a Clearance Groove 112 at the point of attachment to the step shaft to ensure the dimensional accuracy of the Overshooting Fitting Surfaces 111, the two Overshooting Fitting Surface 111 correspond to two Cutting Insert Fitting Surface 211 to cooperate with each other to ensure the axial overlap precision of the cutting insert 100 and the Limit Fitting Surface 200, and the avoidance slot 212 on the Fitting Section 110 corresponds to the avoidance slot 212 of the Cutting Insert Fitting Holes 210.

As shown in FIGS. 3-4, the end face of the cutting support rod 200 connected to the cutting insert 100 is a Limit Facing Surface 201, and the portion of the cutting insert 100 that is exposed on the outside in the cutting support rod 100 and the step shaft mating end is a Limit Insert Fitting Surface 101, the Limit Insert Fitting Surface 101 and the Limit Facing Surface 201 are mutually matched to ensure the radial re-combination accuracy of the cutting insert 100 and the cutting insert 200.

As shown in FIG. 2, the cutting support rod 200 is provided with a Support rod Fitting Surfaces 202 at one end of the tool holder 200 away from the cutting head 100, and the tool holder 300 is provided with a tool holder mating hole 301 in the centre of the side connected to the Cutting Insert Insert Fitting Holes 200, the Support rod Fitting Surfaces 202 is connected to the tool holder mating hole 301 in an Overshooting Fitting Surface connection to allow the tool holder 300 and the Cutting Insert Fitting Surface to be tightly connected.

As shown in FIGS. 2-3, a Main Cooling Holes 130 is provided in the centre of the Blade Tip 100, a Cutting Edge 102 is disposed circumferentially uniformly at one end of the Blade Tip 100 away from the Threaded Fasteners 200, and Support Cooling Holes 131 are disposed circumferentially uniformly at one side of the Blade Tip 100 adjacent to the Cutting Edge 102, which are used for discharging a cooling medium to give the Cutting Edge 102 a cool down and to remove swarf, and all Support Cooling Holes 131 are connected to the Main Cooling Holes 130, and the Threaded Fasteners 500 is provided in the centre of the Threaded Fasteners 500. Cooling through holes 540 are provided in the centre of the Threaded fasteners 500, the cooling through holes 540 connect the Main Cooling Holes with the through holes 400 of the tool holder 300, so that the cooling medium can pass through the through holes 400 of the tool holder 300, enter the cooling through holes 540 of the Threaded fasteners 500, and then enter the Main Cooling Holes 130.

Finally, the above embodiments are only used to illustrate the technical solutions of the present invention rather than limitations, although the present invention has been described in detail with reference to the preferred embodiments, the person of ordinary skill in the art should understand that modifications or equivalent replacements can be made to the technical solutions of the present invention without departing from the purpose and scope of the technical solutions of the present invention, which should be covered by the scope of the claims of the present invention.

What is claimed is:

1. A quick-change type tool holder structure with high positioning accuracy, characterised in that it comprises a cutting insert, the support support rods and the tool holder connected in sequence, said the support rod and the tool holder having a through hole in the centre of the tool holder, said through hole being provided with a Threaded fasteners, said Threaded fasteners being connected to the cutting insert and the tool holder at both ends respectively, said through hole of the support rod being set as a Limit Fitting Surface in the inner cylindrical surface of the support rod near the end of the cutting insert, and said Limit Fitting Surface fitting holes in the cutting insert.

2. A quick-change type tool holder structure with high positioning accuracy as claimed in claim 1, characterised in that one end of said Threaded fasteners is provided with a threaded hole for connecting with the tool holder, and the other end of said Threaded fasteners is provided with male threads for connecting with the tool holder.

3. A quick-change type tool holder structure with high positioning accuracy as claimed in claim 2, characterised in that: said Threaded fasteners are provided with Allen keyhole near the male threads side.

4. A quick-change type tool holder structure with high positioning accuracy as claimed in claim 2, characterised in that: said the tool holder is provided with a step shaft at one end of the tool holder, a Primary End of said step shaft is a Fitting Section, a secondary end of said step shaft is a Threaded Column, said Threaded Column is connected with an Threaded hole, and said Fitting Section is tool holdered in the Limit Fitting Surface.

5. A quick-change type tool holder structure with high positioning accuracy as claimed in claim 4, characterised in that said Limit Fitting Surface comprises two Cutting Insert Fitting Holes, and an avoidance slot is provided between the two said Cutting Insert Fitting Holes.

6. A quick-change type tool holder structure with high positioning accuracy as claimed in claim 5, characterised in that: said Fitting Section includes two Overhooting Insert Fitting Surfaces, and an avoidance slot is also provided between the two said Overhooting Insert Fitting Surfaces, a Clearance Groove is provided at the point of connection of said tool holder with the step shaft, and the two said Overhooting Insert Fitting Surfaces are mated with each other in response to the two Limit Fitting Surface, the avoidance slots on the said Fitting Section correspond to each other with the avoidance slots in the tool holder mating holes. The two said interference fit surfaces correspond to each other on the two cutting insert mating surfaces, and said clearance groove on the mating part corresponds to the clearance groove of the cutting insert mating hole.

7. A quick-change type tool holder structure with high positioning accuracy as claimed in claim 6, characterised in that: the end face of said Cutting Insert Fitting Surface with which said The Support rod Fitting Surface is connected is a Limit Fitting Surface, the portion of said Cutting Insert Fitting Surface which is exposed on the outside in the end of said Cutting Insert Fitting Surface which is mated to the step shaft is a Limit Fitting Surface, and said Limit Fitting Surface is mated to the Limit Fitting Surface.

8. A quick-change type tool holder structure with high positioning accuracy as claimed in claim 1, characterised in that: said Cutting Insert is provided with a Main Cooling Holes in the centre of the tool insert, said Cutting Insert has a Cutting edge circumferentially uniformly distributed at one end of the tool holder away from the support rod, said cutting insert has a Support Cooling Holes circumferentially uniformly distributed at the side of the tool holder near the Cutting edge, all said Support Cooling Holes are connected to the Main Cooling Holes, said Threaded fasteners are provided with a through-hole in the centre of the support rod, said Cooling Holes are connected to the Main Cooling Passage with the through hole of the tool holder.

9. A quick-change type tool holder structure with high positioning accuracy as claimed in claim 1, characterised in that: said Limit Fitting Surface are set as a Support rod Fitting Surface at the end of said support rod away from the Cutting Insert Fitting Holes, said tool holder mating holes are provided in the centre of said tool holder on the side of the Limit Fitting Surface, said The Support rod Fitting Surfaces and said tool holder mating holes are connected with the Cutting Insert Fitting Holes in excess of surplus fit.

10. A quick-change type tool holder structure with high positioning accuracy as claimed in claim 9, characterised in that: said tool support support rod is made of carbide, and said cutting insert and tool holder are made of alloy steel.
